(19) United States
(12) Patent Application Publication
(10) Pub. No.: US 2006/0255068 A1
(43) Pub. Date: Nov. 16, 2006

(54) Flexible film package with integral dosing pump

(76) Inventor: Amir Genosar, Lafayette, CO (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/549,999

(22) PCT Filed: Feb. 17, 2004
(86) PCT No.: PCT/IL04/00145

§ 371 Date: May 25, 2006

(30) Foreign Application Priority Data
Mar. 23, 2003 (IL) 155,033

(51) Int. Cl. B65D 37/00

(52) U.S. Cl. 222/207; 222/211

(57) ABSTRACT

The present invention provides a liquid dispensing package (10) comprising a flexible film package formed with at least two spaced apart major surfaces joined to each other along their peripheral edges (12) and delimiting therebetween a liquid containing chamber, said package further comprising an integral dosing pump and at least one button (16) to operate the pump. The at least one button (16) is located adjacent to an edge (12) of the package (10).

The present invention relates to the field of dispensers and packaging. More specifically, the present invention relates to a flexible film package for the controlled dispensing and dosing of liquid products, either as a spray or in a liquid form, wherein said dispenser is formed as a compact, self-contained unitary container and pump with integral valve means.

### BACKGROUND OF THE INVENTION

Flexible packaging is increasingly becoming one of the primary forms of consumer packaging for both solid and liquid products. Packages of this kind include everything from simple packages for dried goods, to sophisticated contoured designs that function as stand-up pouches, flat pouches or even box shapes. Additional forms of flexible packaging include flexible blisters or sachets. As regards cost, flexible foil packages are an economical packaging solution, allow compact shipping to the filler, can include improved barrier media and are suitable for high-quality printing and finishing.

A parallel trend in packaging is the use of dispensing pumps to enable the consumer to issue a dose of a product by merely pressing down on the top of such pump. Common household items using such a dispensing pump attached to a rigid bottle include liquid soaps and detergents. Given that such pumps need to be pressed down into a rigid container in order to work, and that flexible packaging is by definition non-rigid, the integration of a conventional dispensing pump and a flexible package is problematic. Thus, although the ability to dose from a flexible package would seem desirable, current dosing mechanisms are inappropriate. Accordingly, in order to combine a dosing mechanism with a flexible package, the flexible package needs to be housed inside a rigid holder, where the dosing pump is attached to said rigid holder.

The prior art in flexible packaging does contain a number of innovations related to the issue of dosing, but none provide an integral method of accomplishing this. U.S. Pat. No. 6,007,264 describes an integral packaging applicator which comprises a design for a flexible package where the sheets from which said is fabricated extend beyond the nozzle so as to form an applicator. This design thus incorporates the directional aspects of an applicator but does not incorporate any element of dosing, as the control over the quantity of liquid issued is purely a function of the squeezing of the package. The issue of dispensing is addressed in U.S. Pat. No. 5,791,519; U.S. Pat. No. 5,975,359 and U.S. Pat. No. 5,992,691; but in all of these cases the dosing mechanism is contained in a separate device, connected via a conduit to a needle inserted into the flexible package. Similarly, commercial products incorporating a diaphragm pump attached to the end of a flexible package are also known. U.S. Pat. No. 5,996,854 describes one-handed dispensing from a liquid dispensing package, by the use of a self-closing flat-channel valve. This design does enable a more constant flow to be issued from the package when squeezing the package, but still does not constitute a true dosing mechanism. Thus there is no description in the prior art of a flexible package having a dosing mechanism as an integral component.

It is therefore the object of this invention to provide a flexible liquid dispensing package with an integral dispensing and dosing mechanism.

It is also the object of the present invention to enable one-handed operation whereby the consumer can hold the package by hand while operating the integral dispensing mechanism by pressing with his fingers.

It is a further object of this invention to prevent any unintentional release of the liquid contents of the package caused by squeezing of the package.

It is furthermore the object of the present invention to enable simple and inexpensive fabrication of said packages based around the use of an injected plastic part, which is integral to the flexible package.

These and other objects of this invention will become more evident in the summary of the invention and in the description of the preferred embodiment.

### SUMMARY OF THE INVENTION

According to the present invention there is now provided a liquid dispensing package comprising a flexible film package formed with at least two spaced apart major surfaces joined to each other along their peripheral edges and delimiting therebetween a liquid containing chamber, said package further comprising an integral dosing pump and at least one button to operate said pump, said at least one button being provided adjacent to an edge of the package.

In preferred embodiments of the present invention wherein said pump comprises a pumping chamber where said button constitutes the side wall of said chamber, an inlet valve through which the uptake of the liquid contents from said liquid containing chamber is performed, and an outlet valve through which the contents of said pumping chamber are dispensed.

Preferably said button is a formed section of said package, where said forming is accomplished by thermoforming and embossing; such that a cavity is created, said cavity constituting a pumping chamber.

In especially preferred embodiments of the present invention said inlet valve enables the uptake of liquid from the base of said package via an uptake conduit formed in said package by welding.

Preferably return of said button to its initial position transfers said liquid from said uptake conduit to said pumping chamber which in turn sucks a further dose of said liquid from said liquid containing chamber into said uptake conduit.

In preferred embodiments of the present invention, the integral dosing pump comprises an inlet valve, a non-return product dispensing valve and a pumping chamber which is internal to the package; the arrangement being such that said dispenser is formed as a compact, self-contained unitary container and pump and depression of the pumping button to its displaced position causes liquid contained in said pumping chamber to be expelled via said product dispensing valve and return of said button to its first normal position causes liquid to enter said pumping chamber via said inlet valve.

In preferred embodiments of the present invention said liquid dispenser further comprises an uptake tube in fluid communication with said inlet valve and positioned to deliver liquid to said pumping chamber upon return of said pumping button to its first pumping position.

In further preferred embodiments of the present invention said button comprises an embossed or thermoformed section of the side of the package, which encloses one side of said pumping chamber.

In still further preferred embodiments of the present invention two such said buttons are provided, one along each along each side of the pumping chamber.

As will be realized the present invention relates to a packaging system offering greater convenience and different form factors than those provided by existing systems. The dispenser of the current invention consists of a flexible film packaging container such as a stand-up pouch containing an integral dispensing mechanism such that the consumer can hold said container or package in his or her hand while manipulating the dispensing mechanism with his or her fingers. The pressure applied to the button or buttons is applied, preferably between the thumb and the forefinger in such a manner as to squeeze the two sides of the package together at that point. Advantageously, this construction and method of operation thus overcomes the problem inherent in trying to depress a more conventional type of dispensing pump into a flexible container.

The button(s) serves to pump out the liquid contents of the flexible package of the present invention in measured doses. The pressure resulting from the depression of the button causes the liquid in the pump chamber to be forced out of the outlet valve, where it exits via the nozzle connected to this valve. When the button is released, said button is arranged to regain its former position or shape, either due to a spring action or due to the button's internal structural stress. This causes low pressure within the package, which in turn causes the liquid contents to fill up the pumping chamber through the intake tube via the inlet valve. Typically the pumping of the liquid contents of the package in this manner causes the gradual contraction of the package. In a variant of this design, an air compensation valve is provided, whereby air is enabled to enter the package to take the place of the pumped liquid.

In a preferred embodiment of the invention, the button is a thermoformed or embossed section of the side of the flexible package, and thus the total parts count is kept at a minimum. Said thermoformed or embossed section can be pre-treated to attain the desired mechanical properties by a number of methods, including but not limited to local coating, laminating and heat treatment. In a further preferred embodiment, the valves and nozzle are all part of one injected plastic part.

In a further preferred embodiment of the invention, dispensing of the liquid contents of the package is only possible by depressing the pumping chamber provided, whereas squeezing of the package as a whole serves to prevent any dispensing occurring.

In preferred embodiments said dispenser further comprises a nozzle in fluid communication with said outlet valve.

Preferably said package further comprises a tamper-indication tab formed as part of the flexible package, where the removal of said tab exposes the nozzle.

In a first embodiment said nozzle is a spray nozzle.

In further embodiments said nozzle can be swivelled to extend away from the dispenser.

Preferably the frame of said pumping chamber is an injection-molded plastic part and at least part of said valves are an integral component of said injection-molded plastic part.

In other embodiments of the present invention said pump further comprises a non-return pressure-compensation valve leading into said package from the atmosphere.

In yet further embodiments of the present invention said button has an initial and a depressed position, wherein after depression, said button is able to return to its initial position due to air inflow via said pressure-compensation valve.

As will be realized the liquid dispensing package according to the present invention can be used in conjunction with a variety of liquids and in preferred embodiments of the present invention said liquid is selected from the group consisting of a perfume, an eau de toilet, a breath freshener, a shampoo, a liquid soap, a shaving gel, a hair conditioner, a comestible substance, snuff, an inhalable medicine, an oil, water-based paint, oil-based paint or shoe polish.

As an added feature the liquid dispensing package according to the present invention is further provided with a manually actuated safety valve, which cannot be operated by a young child.

Similarly, the liquid dispensing package according to the present invention can further be provided with a mechanism whereby squeezing of said package other than via the button provided will serve to prevent any dispensing taking place.

Said package can further be provided with a selector enabling the deactivation of said squeeze-prevention mechanism.

In especially preferred embodiments of the present invention the configuration of the package is selected from the group consisting of a stand up pouch, a flat pouch and a sachet.

Said package can further incorporate an isolated compartment for storage of at least one related item.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

The invention is herein described, by way of example only, with reference to the accompanying drawings, wherein:

FIG. 1 illustrates the main components of a preferred, stand-up pouch embodiment of the flexible package of the current invention;

FIG. 2 provides an isometric view of the rigid plastic part of this package, containing the frame for the pumping chamber and the valves;

FIG. 3 shows a cut-away view showing the placement of the rigid plastic part inside the package;

FIG. 4 shows a preferred embodiment for welding the rigid plastic part into the package;

FIG. 5 illustrates the operation of the valves integral to the rigid plastic part;

FIG. 6 shows a cross-sectional view of the entire pumping mechanism;

FIG. 7 provides an isometric view of a further preferred, flat-pouch embodiment of the flexible package of the current invention;

FIG. 8 shows a preferred embodiment of the rigid plastic part in which dispensing of the liquid contents of the package simply by squeezing the package (as opposed to pressing the button) is prevented;

FIG. 9 illustrates a further preferred embodiment of said plastic part, wherein a manual shut-off valve is added;

FIG. 10 illustrates a preferred embodiment for the valves wherein thermoformed or embossed areas of the package walls constitute the diaphragms for the valves; and

FIG. 11 shows how the package of the present invention can be implemented in sachet configurations.

### DETAILED DESCRIPTION OF THE DRAWINGS

The present invention will be described in detail according to the preferred embodiments illustrated in the accompanying drawings. Like reference numerals are used to identify identical components in the various views.

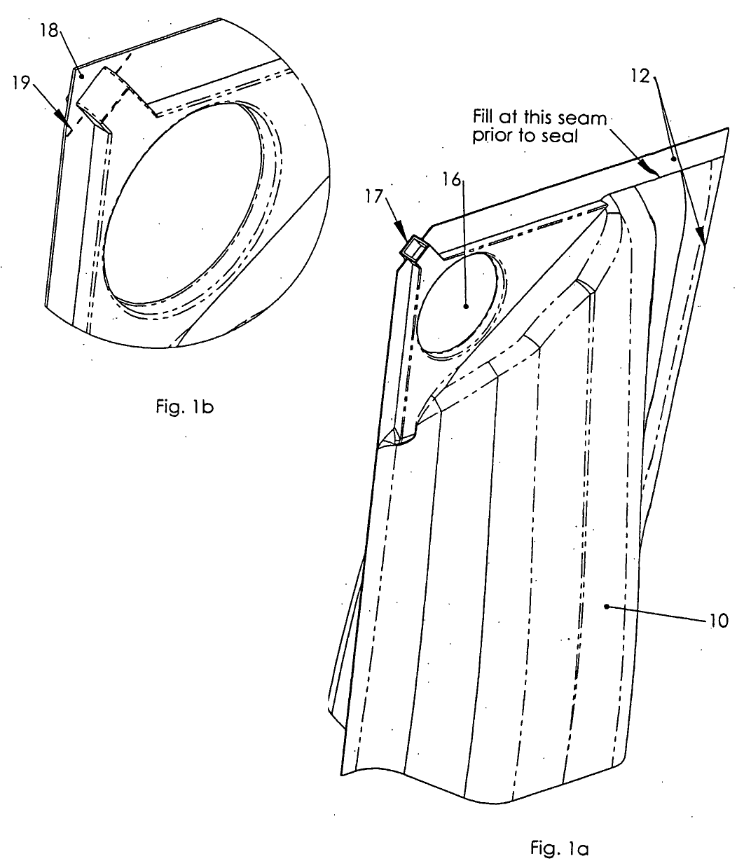

Referring to FIG. 1, an overview of a preferred embodiment of the dispensing package is shown. The package 10 is a stand-up pouch or “Doy pack”, heat-sealed or welded around the edges 12 to close the package, together with a gusset at the base. The package is constructed using standard flexible-packaging materials including but not limited to polyester (PE), polypropylene (PP), oriented polypropylene (OPP) and polyvinylidene chloride (PVDC), PET, PET-A, PET-G, PVC, HEPS and BONYL. Often these materials are fabricated in multi-layer films such as PVC/PE, HEPS/PE, PE/BONYL/PP and PET/BONYL; sometimes together with a layer of barrier material such as aluminum where required. Typical widths of such films range between 30 microns and 250 microns. One corner of the package 10 integrates a pumping mechanism comprising a rigid plastic part inserted within the package 10 and a pumping button 16 located adjacent to the edge of the package. On grasping the area of the package around said button 16 and depressing it, the liquid contents of said package are dosed via the outlet nozzle 17. As the depression action performed by the consumer is applied between the two sides of the package at this point 16, the lack of rigidity of package as a whole does not constitute a drawback. Accordingly, the requirement for rigidity, as required by containers using standard dispensing pumps, is obviated. Advantageously, this principle enables the inexpensive fabrication of a dosing package with a sharply reduced parts count, and one in which the transportation of the package to the filling line minimizes shipping costs as the empty pouches are wound flat on a reel.

In a further preferred embodiment (shown in FIG. 1b), prior to first use the nozzle 17 is sealed by a tamper evident “shipping seal” 18, which is broken off along the weakened section 19. To remove the shipping seal 18, any one of a variety of well-known opening means can be used. For example, a pre-cut notch can be provided at the sides of the nozzle 17 so that the consumer can open the shipping seal 18 by tearing or cutting across the width of the nozzle 18 to provide a mouth. A groove or score line 19 can be provided to a partial depth of either sheet by mechanical or laser cutting, or scoring. Co-extruded material having a certain weak joint can be utilized, or laminated sheets having sub-layer perforation can be utilized for ease of tearing.

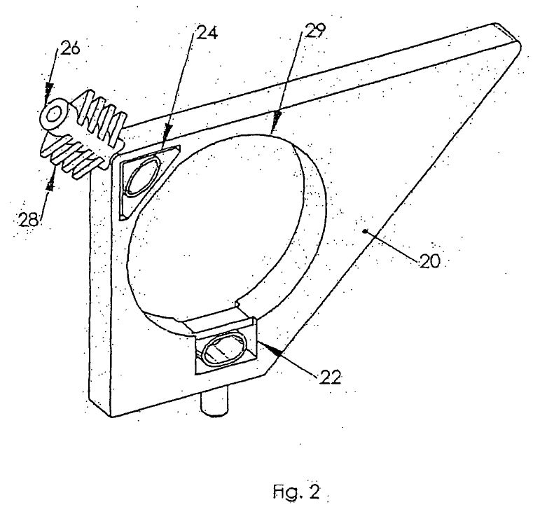

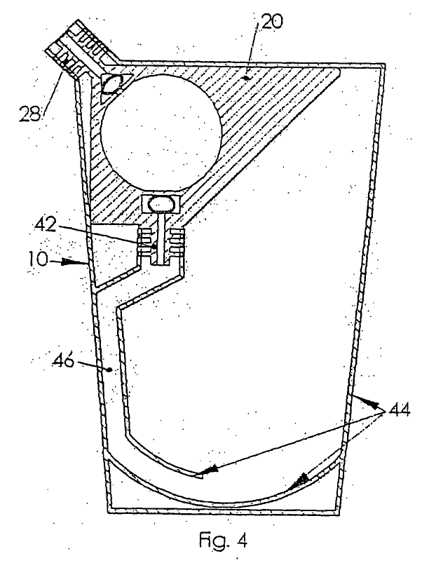

Referring now to FIG. 2, the rigid plastic component 20 of the pumping mechanism is shown. This component 20 comprises a non-return inlet valve 22, a non-return outlet valve 24, a fin-shaped joint 28 and an outlet nozzle 26. The interior frame 29 forms the base of a pumping chamber, said pumping chamber being completed by a formed button attached to said frame 29 or by two such buttons attached one either side of said frame 29. The outlet valve 24 is connected to the nozzle 26 through which the liquid contents of the package 10 may be dispensed. The joint 28 serves to connect the nozzle end of this part 20 to the corner of the package, typically by welding, as illustrated in FIG. 4 below. This rigid plastic component 20 can be fabricated from any plastic material including but not limited to polyester (PE) and polyvinyl chloride (PVC). In general, the selection of the plastic material for this component will be a function of its desired material characteristics, compatibility with the planned liquid contents for the package type, and the ease of welding to the flexible foils from which the package is made,. For example, if the foil is a multi-layer foil with a PE layer on the inside, then the choice of PE for the component will ensure a good weld.

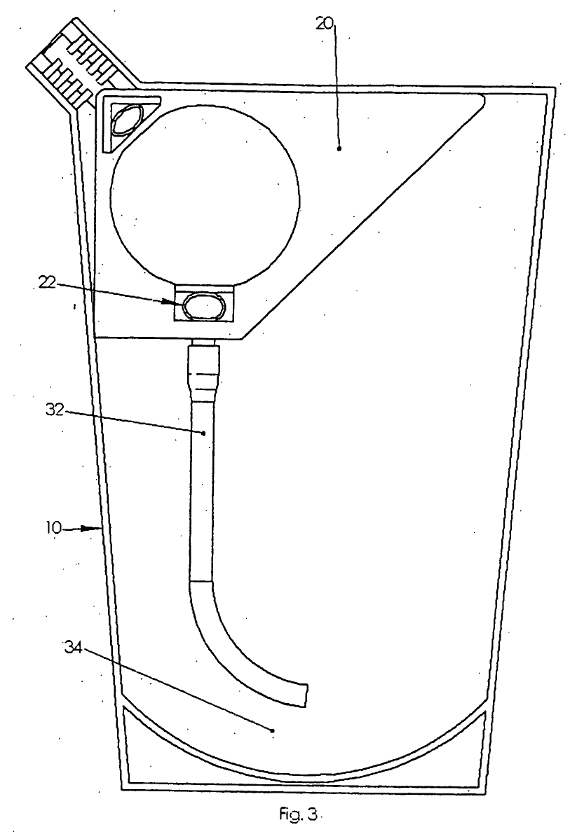

Referring now to FIG. 3, a cut-away view of the package 10 is shown, illustrating the liquid uptake mechanism. The inlet valve 22 of the plastic part 20 is connected to a conduit or straw 32, which leads to the base of the package 34. In this preferred embodiment the dispensing action doses liquid brought from the base 34 of the package and thus the need to tip the package 10 upside down is obviated. This is advantageous for those cases where the dosing of the liquid is to take place while the package 10 is held upright.

FIG. 4 shows an alternative means of integrating the plastic part 20 into the package 10. The welding areas 44 show the attachment of the joints at the inlet 42 and outlet 28. The welds are also used to create a conduit 46 to the base of the package, thereby obviating the need for a straw to perform this function and, advantageously, reducing the parts count still further. The design is such that said conduit 46 is substantially rigid and will not collapse when suction of liquid to the pump occurs. Said rigidity can be achieved by a number of means, including: forming the conduit section of the foil such that it has a half-cylinder geometry; using a rigid foil; making the welding in a way that constrains the foils to keep a gap between the two welding lines that define the conduit; or by implementing an insert between the two welding lines that define the conduit, wherein said insert keeps the foils apart in the conduit section.

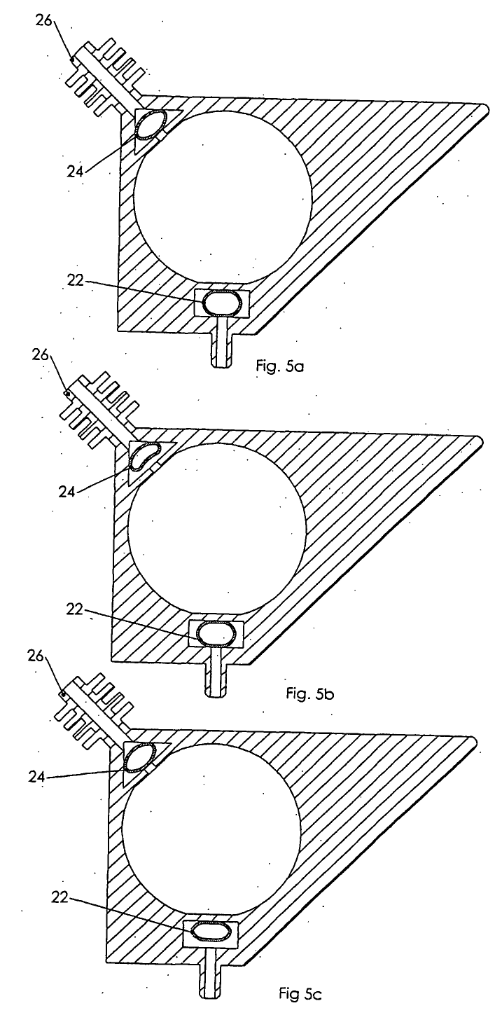

Referring now to FIG. 5, the role of the valves is illustrated. FIG. 5a shows the situation at rest, where both the inlet valve 22 and the outlet valve 24 are closed. FIG. 5b shows the state of the valves on discharge, when the pumping chamber is compressed. During this discharge, the outlet valve 24 is forced open by pressure, and the contents of the pumping chamber are expelled via the nozzle 26. FIG. 5c illustrates what then happens as the pumping button regains its formed shape: the low pressure within the pumping chamber causes the outlet valve to return to its normally closed position and to be further compressed onto the sealing surface, and at the same time causes inlet valve 22 to open, enabling the liquid contents of the package to be sucked into the pumping chamber, awaiting the next pumping action. Advantageously, by having a delay in the return of the outlet valve 24 to its closed position, a small suck-back from the nozzle will be gained, and this is useful in keeping the end of the nozzle 17 clean after use. Such a delay can be achieved by several methods, including having a long travel of the sealing element between its open and closed positions, by a viscous interaction between the sealing element and the fluid as it moves, or by making the sealing element out of elastic materials with large tensile hysteresis.

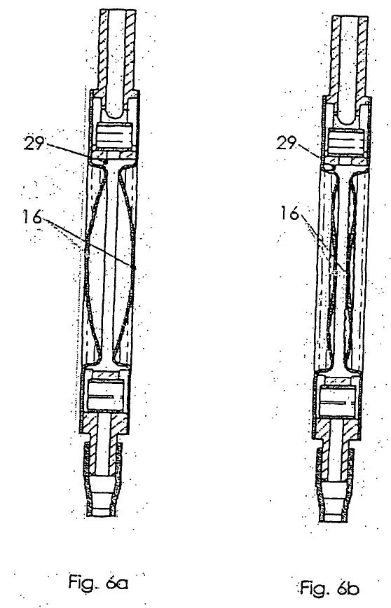

Referring now to FIG. 6, a cross-section of the fully-assembled two-button embodiment of the pumping chamber is shown. FIG. 6a shows the buttons 16 at their rest position, and FIG. 6b shows them immediately following discharge. As shown, the buttons 16 are attached around the interior frame 29 of the rigid plastic part, thereby forming a pumping chamber. In a preferred embodiment of the present invention, said buttons 16 are a thermoformed or embossed section of the film from which the package is constructed. The volume reduction of the pumping chamber between the two states shown determines the volume dosed with each such pumping action. This volume is approximately halved by using only one button 16 while leaving a straight wall on the other side of the frame 29.

In a preferred embodiment of the package, it is the internal stress of the button then causes said button to resume its initial shape, the low pressure resulting from this causing the next dose of liquid from the package to enter the pumping chamber. As the liquid contents are repeatedly dosed in this manner, the package will contract as its contents are evacuated. If this is not desirable for aesthetic reasons, then a further preferred embodiment employs an air-compensation valve (not shown), which may also be implemented in the plastic component, to permit air inflow to compensate for the volume loss due to the pumping action, Alternatively, a small hole may be formed or exposed in the package by the consumer when tearing off the tamper-evident corner. A number of alternative embodiments of button mechanisms for the package of the present invention are possible, including plungers supported by a spring and a bellows-type button.

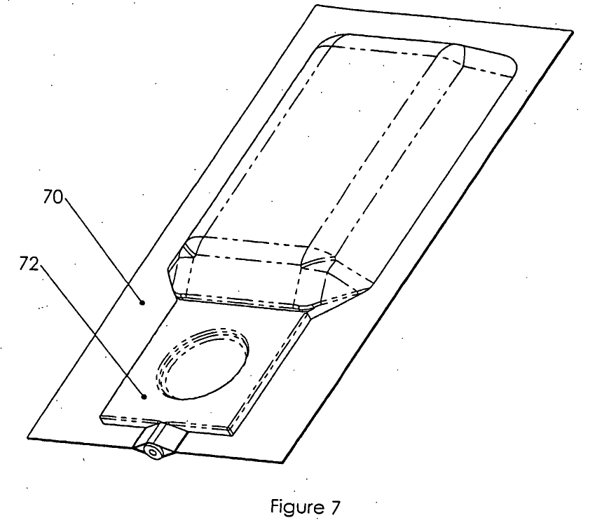

Referring now to FIG. 7, a flat-pouch embodiment of the flexible package of the current invention is shown. Such pouches are commonly used in one-touch soap dispensers in lavatories, where a wall-mounted holder includes the pumping mechanism. In the preferred embodiment shown, the pouch 70 contains an integral pumping mechanism 72, where said mechanism 72 is integrated into the base of the pouch. Essentially this is the same design as described above, but with the differences that: (a) the pumping mechanism is located at the base of the pouch rather than the top, and (b) no conduit is required to lead the liquid to the pump. As above, the integral rigid plastic part welded into the film package provides the frame for the pumping chamber, where the button(s) are implemented by thermoforming or embossing a plastic cover over said frame. Said button(s) are formed either out of a plastic sheet or out of the film from which the flat-pouch itself is fabricated. Advantageously, this integration of pumping mechanism into the pouch simplifies the fabrication of the holder such that it now requires no moving parts, and obviates the requirement to maintain the mechanism in such holders.

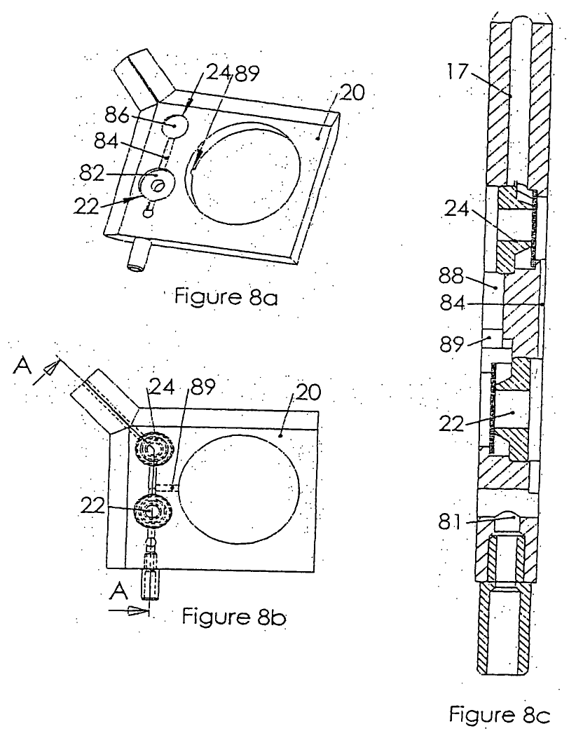

Referring now to FIG. 8, a preferred embodiment of the rigid plastic part is shown, said embodiment preventing unintentional dispensing of the liquid contents of the package due to squeezing of the package. FIG. 8a provides an isometric view of the rigid plastic component 20, showing a cut-away view of the fluid path 84 between the fluid inlet 82 of the inlet valve 22 and the diaphragm 86 of the outlet valve 24. The purpose of said fluid connection 84 is to provide pressure to the back of the diaphragm 86 of the outlet valve 24 when pressure is exerted on the walls of the package. In this way, any squeezing applied to the package as a whole (as opposed to the pumping chamber) will serve to close the outlet valve 24. The liquid paths along the line marked A-A in this embodiment (as shown in FIG. 8b) are detailed in FIG. 8c. As shown in FIG. 8c, during normal operation, liquid entering through the inlet path 81 in response to low pressure in the pumping chamber is led to the inlet valve 22 and from there, via fluid path 88, into the pumping chamber along the fluid path perpendicular to this view 89. On a subsequent depression of the pumping chamber, said liquid is expelled back through said perpendicular path 89, and along said fluid path 88 in the direction of the outlet valve 24, from where it is emitted at the nozzle 17. During normal operation, said outlet valve 24 will open at this point. As both the inlet valve 22 and the outlet valve 24 are check-valves which operate in response to the pressure difference on the valve in the direction of flow, squeezing the package will cause a pressure build-up in the package, resulting in the opening of both these valves and a continuous dispensing of the package's contents until the squeeze is released. However, in some applications this feature would not be desired, and thus a safety automatic shut-off mechanism is provided to limit dispensing such that it takes place solely in response to pressing the dispensing button 16. Due to the presence of an additional fluid path 84 leading from the fluid inlet path 81 to the back of the diaphragm 86 of the outlet valve 24, a increase in pressure within the package will be introduced to the back of the outlet valve diaphragm 86; thus bypassing the pumping mechanism and resulting in a compression of said diaphragm 86 onto the sealing surface of the outlet valve 24. Said compression will seal the fluid path to the nozzle 17 unless the pumping button 16 is pressed so as to overcome this shut-off mechanism. In this manner, squeezing of the package will serve to prevent any dispensing taking place; and thus the only means of using the package of the present invention will be by means of the dosing mechanism provided. Advantageously, this feature will prevent inadvertent dispensing of the package's contents during handling. If for whatever reason, it is decided to enable squeezing out of the package's contents, then this functionality is implemented by simply omitting the fluid path 84 to the back of the diaphragm 86 of the outlet valve 24. As will be obvious to one skilled in the art, said fluid path 84 serving to prevent the opening the outlet valve 24 may connect to the interior of the package via a number of routes, not limited to the specific embodiment shown. This connection ensures that any pressure originating from the interior of the package will serve to close the outlet valve. In a further preferred embodiment (not shown), the package is further provided with manual selector switch or valve to enable the deactivation of the above described squeeze-prevention mechanism.

As will be obvious to those skilled in the art, a number of alternative embodiments exist for the nozzle part of the package, including but not limited to such structures as needle and catheter-type nozzles. For example the nozzle may terminate in a cap or other closure; the nozzle may be a rotating one, either with or without a shut-off valve; the nozzle may incorporate a special applicator such as a brush for paints, a dropper for eye drops or nasal drops, a foam pad for polish application or a shaping nozzle for food decorations. A notch on the nozzle may serve to snap off a tamper-proof portion at the end of the nozzle. Alternative or additional seal and tamper proof indication may be provided by a foil layer covering said nozzle. The nozzles employed may be either rigid or flexible. Additionally, the nozzle can include an additional cut-off valve, thereby providing an extra safety feature.

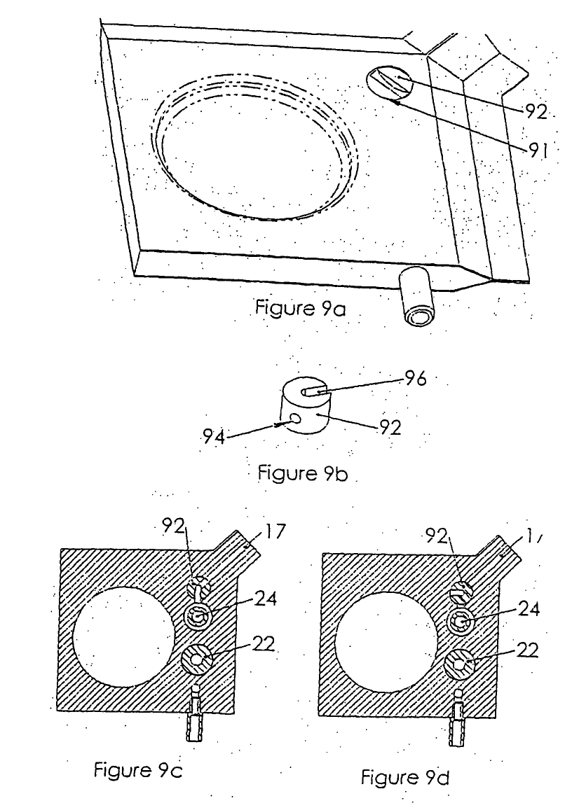

Referring now to FIG. 9, a preferred embodiment of said plastic part incorporating a manual shut-off valve 92 is shown. FIG. 9a shows the cut out 91 in the foil of the package, which enables access to operate the cut-off valve 92. In this embodiment, said cut-off valve 92 can be manipulated with a coin or a screwdriver, thereby advantageously providing an additional safety feature. FIG. 9b illustrates an isometric view of this manual shut-off valve 92, where the outlet opening 94 is in fluid connection with the inlet groove 96. In FIG. 9c, the shut-off valve 92 is shown in its open position where the cut-away section shows the liquid path proceeding from the outlet valve 24, through the shut-off valve 92 to the nozzle 17. By rotating said shut-off valve 92, this liquid path is cut off, as shown in FIG. 9d. As will be obvious to one skilled in the art, a number of shut-off valves as known in the art could be equally well employed. For example, a part of the nozzle 17 could fold over to keep the package sealed and be flipped up in order to dispense the contents, or some other kind of external faucet could be used. Note that the above-described manual shut-off valve does not have to be located as described above, but could, as an alternative or in addition, be located between the liquid contents and the pumping mechanism. Furthermore, any of these manual valves could be designed as a safety valve, which cannot be operated by a young child. Other methods of preventing unwanted emission of the liquid contents from the package include methods to preventing accidental depression of the button 16. Such methods include the use of a sliding or rotating cover which can be positioned across the top of the button, where said cover needs to be moved aside in order to obtain access to the button.

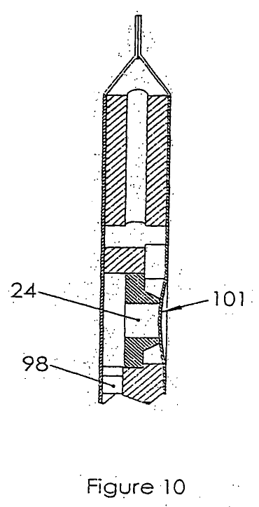

The valve mechanisms used for the inlet 22 and outlet valves 24 may be any type of pressure valve (also known as check-valves) as known in the art. In addition to the membrane valves shown above, any other type of spring or leaf valve may be used, and their orientations may be either parallel (in-line) to or perpendicular (deviated) to the liquid flow. If the valve mechanism is entirely implemented in plastic, then it may advantageously be part of a single molded part constituting the entire rigid plastic component 20. Alternatively, the diaphragms may be fabricated from a separate piece of plastic, metal, silicone, rubber or any composite or combination of the above. Given that the flexible foil used for fabricating the package is a plastic material or a multi-layer plastic film, this foil may also serve the function of the diaphragms by being thermoformed or embossed at the appropriate locations. Referring now to FIG. 10, the embodiment shown in FIG. 8c is shown again, but with the difference that, in FIG. 10, a dome formed in the flexible foil constitutes the diaphragm 101 part of outlet valve 24, in place of a dedicated sub-component.

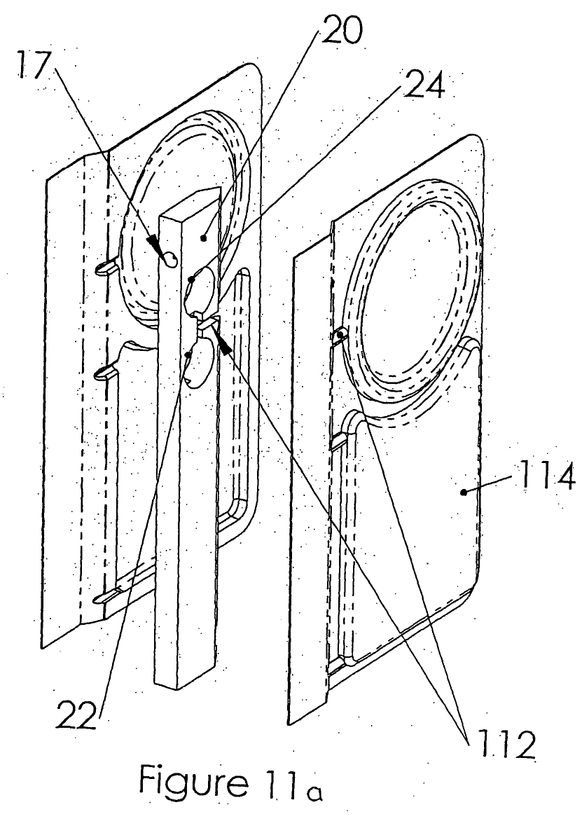

While the descriptions above relate primarily to stand up and flat pouches, the package of the present invention can also be implemented in product configurations including but not limited to soft blisters or sachets. Referring now to FIG. 11, a blister or sachet implementation of the package of the present invention is shown. In this preferred embodiment, the plastic component 20 is implemented as a strip enclosed within the side of the package, said strip incorporating both the inlet 22 and outlet 24 valves, together with the nozzle 17. The rest of the package is composed of a flexible foil into which is welded a reservoir area 114 and a conduit 112 leading into it.

In all the above embodiments, the plastic component 20 is depicted as one integral unit. However, this does not need to be the case, and it would be equally feasible to employ an alternative configuration whereby either the nozzle or either or both of the valves are physically separate from the other elements of this component. Providing that the configuration is such that the parts so divided all work together so as to provide the functionality described above, such an embodiment is equally feasible. In an alternative, albeit lower performance, configuration, a dispenser can be achieved by just forming the two foils and incorporating sealing elements such as rubber spheres for each valve. In this configuration, the plastic component is obviated, but the package will only be suitable for viscous fluids as there is not really a good sealing surface for the sealing element to seal against.

As will be obvious to one skilled in the art, it is possible to provide a duplication of the pumping mechanism within a single package such that it could contain for example, two parallel mechanisms, e.g., one for oil and one for vinegar for making a salad dressing or two separate chemicals for a medical diagnostic, etc. Within the context of dividing the package, it is also possible to have part of the package implement the dispensing mechanism as described above, while having a further section of the package constitute an isolated compartment. Said isolated compartment may serve to hold additional products that are in some way related to the liquid contents of the package. For example, said compartment may hold a paintbrush if the liquid contents are paint, an applicator if the contents are a face crème, a sponge or brush if the contents are a shoe polish, a toothbrush if the contents area toothpaste, etc. In this way, advantageously, the utility of the container is increased while almost no cost is added. Said compartment may open out according to a number of means, including but not limited to having an opening flap, a zip, or a pull-out drawer. Furthermore, said compartment can be formed either as part of the flexible foil or within the plastic component 20.

The package of the present invention can be used to dispense small quantities of liquids such as, for example, a sauce, a crème, a shampoo, a liquid soap, a shaving gel, a hair conditioner, either oil-based or water-based paints, shoe polish, toothpaste, or any liquid comestible substance, etc.

In yet a further embodiment of the invention, a plurality of substances (either all liquids or a combination of at least one liquid and at least one solid) may be stored in the package, each in its own chamber. Said substances can be selectively dispensed separately or together, or caused to mix prior to dispensing by means of an appropriate manually-operated valve. Additionally, one or more of said chambers can be integrated into the plastic component 20, and introduced into the dispensed stream by activating a further button in said component. An additional means of introducing a further liquid into the package of the present invention is to provide a septum in either the foil wall of the package or the plastic component, whereby an external liquid can be injected into the package via said septum. This feature is important in medical applications.

A further enhancement of the package of the present invention involves the inclusion of an electronic module, which may or not be interfaced with any of the valves described above. Said electronic module can serve as a timer, dosage counter, freshness indicator, or cold-chain monitor; or may implement any combination of these functions. In the case that the liquid in the package is a medication, a timer can serve the important function of alerting the patient to the need to take the next dose.

While the invention has been shown herein in what is presently conceived to be the most practical and preferred embodiment thereof, it will be apparent to those of ordinary skill in the art that many modifications may be made thereof within the scope of the invention, which scope is to be accorded the broadest interpretation of the appended claims so as to encompass all equivalent structures and devices.

What is claimed is:

1. A liquid dispensing package comprising a flexible film package formed with at least two spaced apart flexible major surfaces joined to each other along their peripheral edges and delimiting therebetween a liquid containing chamber, said package further comprising an integral dosing pump and at least one button to operate said pump, said at least one button being provided adjacent to an edge of the package, wherein said button is a section of the flexible film from which the package is formed and wherein said pump comprises a) a pumping chamber in which said button constitutes a side wall of said chamber, b) an inlet valve through which the uptake of the liquid contents from said liquid containing chamber is performed, and c) an outlet valve through which the contents of said pumping chamber are dispensed.

2. A liquid dispensing package according to claim 1 wherein said button is a formed section of said package, where said forming is accomplished by thermoforming or embossing; such that a cavity is created, said cavity constituting a pumping chamber.

3. A liquid dispensing package according to the claim 1 wherein said inlet valve enables the uptake of liquid from the base of said package via an uptake conduit formed in said package by welding.

4. A liquid dispensing package according to claim 1 wherein return of said button to its initial position transfers said liquid from said uptake conduit to said pumping chamber which in turn sucks a further dose of said liquid from said liquid containing chamber into said uptake conduit.

5. A liquid dispensing package according to claim 1 wherein said dispenser further comprises a nozzle in fluid communication with said outlet valve.

6. A liquid dispensing package according to claim 5, further comprising a tamper-indication tab formed as part of the flexible package, where the removal of said tab exposes the nozzle.

7. A liquid dispensing package according to claim 5, wherein said nozzle is a spray nozzle.

8. A liquid dispensing package according to claim 5, wherein said nozzle can be swivelled to extend away from the dispenser.

9. A liquid dispensing package according to claim 1, wherein the frame of said pumping chamber is an injection-molded plastic part.

10. A liquid dispensing package according to claim 9, wherein at least part of said valves are an integral component of said injection-molded plastic part.

11. A liquid dispensing package according to claim 1, wherein said pump further comprises a non-return pressure-compensation valve leading into said package from the atmosphere.

12. A liquid dispensing package according to claim 11, wherein said button has an initial and a depressed position, wherein after depression, said button is able to return to its initial position due to air inflow via said pressure-compensation valve.

13. A liquid dispensing package according to claim 1, wherein said liquid is selected from the group consisting of a perfume, an eau de toilet, a breath freshener, a shampoo, a liquid soap, a shaving gel, a hair conditioner, a comestible substance, snuff, an inhalable medicine, an oil, water-based paint, oil-based paint or shoe polish.

14. A liquid dispensing package according to claim 1, further provided with a manually actuated safety valve, which cannot be operated by a young child.

15. A liquid dispensing package according to claim 1, further provided with a mechanism whereby squeezing of said package other than via the button provided will serve to prevent any dispensing taking place.

16. A liquid dispensing package according to claim 15, further provided with a selector enabling the deactivation of said squeeze-prevention mechanism.

17. A liquid dispensing package according to claim 1 wherein its configuration is selected from the group consisting of a stand up pouch, a flat pouch and a sachet.

18. A liquid dispensing package according to claim 1, further incorporating an isolated compartment for storage of at least one related item.
